(19) United States
(12) Patent Application Publication
(10) Pub. No.: US 2025/0067641 A1
(43) Pub. Date: Feb. 27, 2025

(54) BENCH FOR AUTOMATED STAINING OF PETROGRAPHIC SLIDES IN BATCH

(71) Applicant: PETRÓLEO BRASILEIRO S.A. – PETROBRAS, Rio de Janeiro (BR)

(72) Inventors: MARLOS DA COSTA MONCORES, Rio de Janeiro (BR); PABLO LUIGI DAMASCENO, Rio de Janeiro (BR); PALOMA DE BRITO GUIMARAES, Rio de Janeiro (BR)

(73) Assignee: PETRÓLEO BRASILEIRO S.A. – PETROBRAS, Rio de Janeiro (BR)

(21) Appl. No.: 18/769,601

(22) Filed: Jul. 11, 2024

(30) Foreign Application Priority Data
Aug. 23, 2023 (BR) 2020230169320

(51) Int. Cl. G01N 1/31; G01N 35/00

(52) U.S. Cl. CPC G01N 1/312; G01N 35/00029; G01N 35/0099; G01N 2035/00138

(57) ABSTRACT

The present utility model pertains to the field of devices and equipment for preparing samples for microscopic investigation, specifically in the apparatus used for staining these samples, more specifically in the staining of petrographic slides. The new bench model comprises a drying station surrounded by nozzles operated with compressed air injection from a manifold, wherein the nozzles surround said station to ensure rapid and homogeneous drying of the sample and the robotic arm is installed centrally on the bench, which has infinite edges to ensure the flow of liquids that overflow, wherein this liquid material is collected directly in the containment tray located below the main bench. In addition, the staining baskets that move between the vats are shaped in such a way that they accommodate the slides in such a way as to ensure that they remain secure in this support, without disturbing the passage of the solution therethrough. Said model, furthermore, increases the precision of staining standardization and reproducibility, maintaining both the exact contact time with the reagents and the same movements throughout the reaction for any number of samples.

### FIELD OF THE UTILITY MODEL

The present utility model pertains to the field of devices and equipment for preparing samples for microscopic investigation, specifically in the apparatus used for staining these samples, more specifically in staining petrographic slides.

### BACKGROUNDS OF THE MODEL

Staining petrographic slides is an essential practice in the field of Petrology, which is the study of rocks in their microscopic shape and composition. This technique is widely used to make the characteristics and structures of rocks more visible under the petrographic microscope, allowing the identification of minerals, textures and other aspects important for understanding the rocks under study.

Petrographic slides are prepared from rock samples that are collected in the field or obtained from drilling cores. The rock sample is cut into a small, thin chip, usually 30 micrometers (μm) to 50 micrometers (μm) thick. The rock sample is impregnated with resin, glued to a glass base and is then cut and thinned until it reaches the thickness required for the petrographic description, which commonly varies from 30 micrometers (μm) to 50 micrometers (μm).

For visualization under the petrographic microscope, rock slides can be stained with specific stains. The stains used are generally aqueous solutions of stain salts, such as alizarin red and potassium ferricyanide. Each stain highlights specific characteristics of rocks and minerals, making the identification and analysis thereof easier.

The red alizarin solution is used to highlight the presence of calcite crystals in the rock, as well as the intensity of the staining indicates the occurrence of iron ions in the mineral structure. Potassium ferricyanide also helps to highlight the presence of minerals rich in iron, especially in the case of dolomites, which can be classified as ferrous dolomites or ankerites according to the tone acquired after staining.

Over time, several stains and staining techniques have been developed to improve the visualization and identification of specific minerals and structures in petrographic slides. Technological evolution has also contributed to the improvement of the petrographic analyses, including the digitization of images and the use of image analysis software.

However, the process of staining petrographic slides has always been done manually and individually, dealing with one slide at a time. This made staining very time-consuming for large quantities of slides, also generating a lot of waste that could not be reused and with great variability due to the artisanal processes.

Usually, the operation consisted of placing between 2 and 5 ml of the reagent on the slide and letting it act for 45 seconds. Then, the solution was washed with a wash bottle containing distilled water and the residue was collected in a beaker for special disposal.

In short, the technical problem revolves around the difficulty of standardizing and automating the task of staining samples on slides, ensuring the standardization of the staining, maintaining both the exact contact time with the reagents and the movements during the reaction for any number of samples.

### STATE OF THE ART

The search for the history of the model in question resulted in the verification of some relevant documents of the state of the art, which still present unresolved differences and technical deficiencies.

Document US20160011221 refers to an integrated automated slide processing system, especially to stain, to cover and to digitize one or more microscope slides (49) in one turn. Said system comprises, as a single apparatus, at least one incubation drawer, an incubation drawer carrier (1), a manipulation tray (2), a manipulation arm (3), a reagent changing unit (4), a washing and rinsing unit, a drop removal unit, a staining/pipetting unit (13), a coverslipping unit (14), a preview image recording unit (15), a digitizing unit (16) and a control computer (18) electrically connected with and providing control over said units, wherein each of the one or more unstained and un-covered microscope slides with sample to be stained, covered and digitized is arranged in an incubation drawer having sidewalls defining a vertically constrained slide receiving space, and wherein the above listed units form a treating path along which said microscope slide (49) is converted into a stained, covered and, at least partially, digitized microscope slide when simultaneously guided over said treating path upon and in harmony with respective control signals provided by the control computer (18) to the respective units.

The set, according to the specification of US20160011221, is significantly similar to the present utility model, as it encompasses an integrated automated slide processing system, especially for coloring, covering and digitizing one or more microscope slides (49) using a robotic arm and comprising handling trays, etc.

However, the aforementioned American document does not specify that said treatment can be applied to petrographic slides, as it is focused on biological slides, which demand other requirements. The present utility model presents a drying system, which is not found in said document. Furthermore, US20160011221 indicates a droplet removal system, one of whose functions is to prevent the sample from drying out. This system is quite different from the present utility model, which aims precisely at completely drying the sample. In addition, the mechanisms of action are also different because while US20160011221 uses a suction system to remove drops, the present model provides air jets in a specific arrangement for complete drying of the sample and consequent termination of the staining reaction, which sample can be left stained, if it is not efficiently dried.

Document US20140130613 discloses a metallographic system comprising a programmable controller, a robotic arm, a specimen clamping or holding device, a sectioning saw, a mounting station, a polishing station, a specimen preparation station, and an analyzer for examining the specimen. The robotic arm 15 is configured to move the specimen 20, from a specimen loading and delivery device 25, a specimen preparation station 35, to a polishing station 30, and a microscope or other analytical instrument for sample evaluation.

Still in document US20140130613, a specimen holding device 25 is disclosed (FIG. 3). The holding device 25, in one embodiment includes a slotted carousel 26 that receives, transports and labels the samples. The carousel 26 delivers each specimen or coupon 20 to a pen stamp 40 where it is labeled, enabling tracking throughout the analysis process. The technician manually or robotically places the specimen on a loading area 21 in the specimen holding device 25.

In short, the aforementioned American document discloses an automatic system for processing metallographic slides using a robotic arm, which can perform several operations without the assistance of an operator; however, it proposes to coat slides and evaluate this type of coating, which is different from the staining process, due to the different thicknesses of material deposited.

RU2440562C proposes a device comprising a sealed working chamber, support, baths, pans, work table accommodating stations with bath positioning devices, pans, mobile support drive equipped with claw, lifting and driving mechanism and unit of control. The automatic device also incorporates a sealed working chamber with sealing side, a drying chamber, a driven rotation mechanism, a support with “IT” shaped handle, a base of support that is rounded and inclined at 20-70°.

In RU2440562, the inner surface of the side wall of the support supports separators consisting of a comb with an edge thickness of 1÷4 and a spacing width of 1.1÷2.0 of microscope slide thickness. The mobile support drive incorporates a claw made up of a rectangular bucket. Please, note herein that the claw moves along the circular arc within 0-40°. Baths and pans are supplied with eyelets. The stations are equipped with positioning devices made up of pairs of cones with a truncated apex and a cylindrical locating flange, the diameter of which amounts to 0.80=0.95 of the eyelet diameter.

In the aforementioned Russian document, the researcher can program, by means of a touch screen menu, the operation of the stain painting machine on slides (FIG. 1), according to the chosen coloring technique, installed inside the work chamber 1 of the bath 5 with process liquids and pallets 6 in the order corresponding to the machine program, and tripod 15 with slides 16—on the parking station pallet 21. After filling the tripod 15 slides, the operator places the tripod on the pallet, close cover 3 of the staining machine (FIG. 1), the machine detects an untreated tripod and starts the assigned process program using at least two process fluids for staining and washing.

In other words, RU2440562C discloses a device for staining slides causing “stains” in order to identify constituents of a sample and provides staining vats and a unit for retaining excess liquid. However, the aforementioned Russian invention does not provide for a sample bath/immersion system with the possibility of agitation during contact with the solution. On the other hand, the present model, based on the arrangement of a robotic arm, allows for controlled agitation in said bath. Without this agitation, the gas bubbles generated in the reaction of carbonate rocks with the staining acidic solution stain the staining, generating a slide with incomplete staining that needs to be redone and, as staining consumes part of the carbonate, this process is critical for the petrography.

U.S. Pat. No. 390,308 discloses a device with two cooperating displacement means for moving a conveyor to any of a selected number of predetermined positions above the treatment solutions and lowering one or more specimens into the treatment solutions for a selected period of time with a control that allows the selection of the sequence of treatments as well as the duration of the treatments and capable of directing the drive systems to automatically proceed through each of the steps of the selected sequence.

Preferably, in U.S. Pat. No. 390,308, the treatment solutions are arranged orthogonally and transported on a sliding tray that can be extended from the cabinet for refilling or replacement. A particular advantage of the system is the location of the mechanical mechanism and electrical components above the solutions, which prevents damage from drips and spills.

Although U.S. Pat. No. 390,308 provides a system with mechanical components to provide staining of slide samples in a bath by means of two cooperating means of displacement, it is noted that the use of a robotic arm with at least 6 axes enables a leaner bench design, as it allows greater versatility of movement, due to the presence of more degrees of freedom for agitation and consequently less space required for installation.

Furthermore, the present model, by providing a liquid containment compartment, also guarantees greater safety for both workers and the environment, as liquid waste can be disposed of correctly. The use of small sample holders, for staining eight slides, also guarantees less use of staining solution and, consequently, generates less waste for treatment and disposal.

In short, it appears that the new shape or arrangement of the bench is evident in the fact that the base is surrounded by jets of compressed air positioned in different specific positions to ensure rapid and homogeneous drying of the sample and the robotic arm is installed centrally on the bench, which has infinite edges to ensure the flow of overflowing liquids, wherein this liquid material is collected directly in the containment tray located below the main bench. Furthermore, the staining baskets/cradles are shaped in such a way that they accommodate the slides in a way that ensures that they remain secure in this support, without hindering the passage of the solution therethrough.

Said new shape leads to an improvement in the use of said bench as it allows greater versatility of movements of the robotic arm, guarantees greater safety for workers and the environment, as all liquid is collected in the trays, and uses less staining solution and generates, consequently, less waste for treatment and disposal. Furthermore, the aforementioned mechanisms together made it possible to obtain high-quality samples in an automated manner.

In short, a technician in the subject, in possession of the above documents considered separately or in combination, would not have the subsidies to provide in an ordinary or common way the arrangement of the air jets nor the centralization on the bench with infinite edges for direction of the liquid. Furthermore, there is highlighted the specificity of the robotic arm with more than six axes to have more degrees of freedom and agitation.

### BRIEF DESCRIPTION OF THE UTILITY MODEL

The present bench model comprises a drying station (6) surrounded by nozzles operated (2) with compressed air injection from a manifold (10), wherein the nozzles surround said station to ensure rapid drying homogeneous sample and the robotic arm is installed centrally on the bench, which has infinite edges to ensure the flow of liquids that overflow, wherein this liquid material is collected directly in the containment tray (7) located below the main bench. Furthermore, the staining baskets (11) that move inside the vats (40) (41) (42) (43) are shaped in such a way that they accommodate the slides in such a way as to ensure that they remain secure in this support, without disturbing the passage of the solution therethrough. This model, in addition, increases the precision of staining standardization and reproducibility, maintaining both the exact contact time with the reagents and the same movements throughout the reaction for any number of samples.

### BRIEF DESCRIPTION OF THE FIGURES

FIG. 1 represents a perspective view of the bench model for automated staining.

FIG. 2 represents a top view of the bench model for automated staining.

FIG. 3 represents a section A-A of the fluid containment tray together with its exploded perspective view of the model.

FIG. 4 represents a detail of the drying station in an exploded perspective view of the model comprising a removable grid and liquid containment drawer.

FIG. 5 represents three details (D, E, C) of components seen) from above, highlighting some main components.

FIG. 6 discloses a perspective view of the staining basket that is located inside the staining vat.

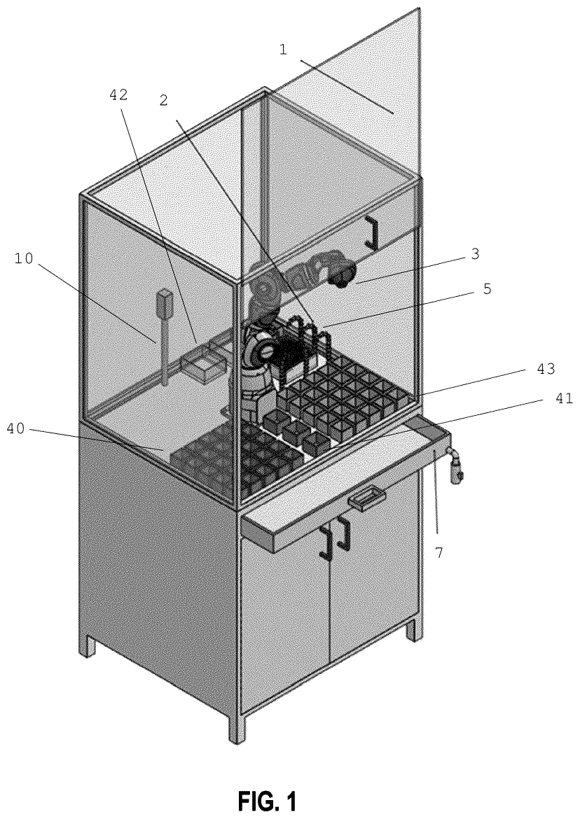

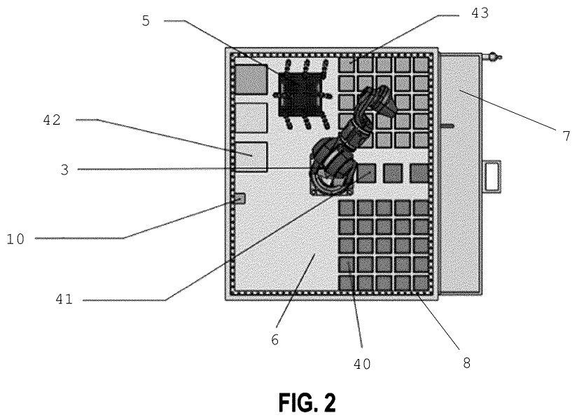

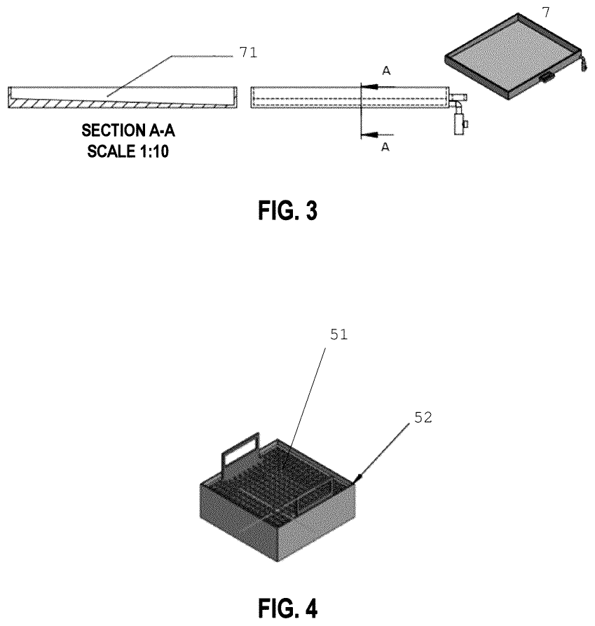

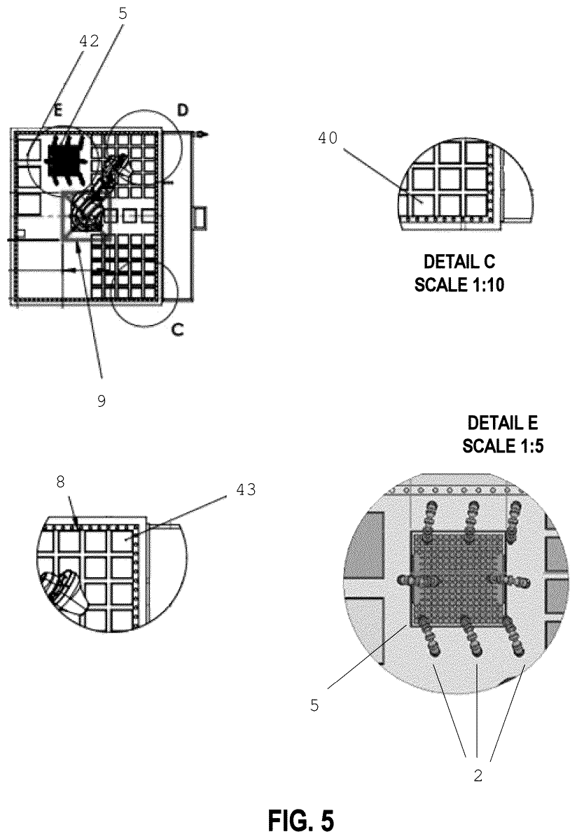

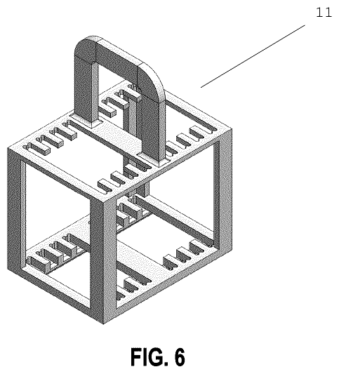

### DETAILED DESCRIPTION OF THE UTILITY MODEL

The present utility model refers to a bench for automated batch staining of petrographic slides that comprises: a parallelepiped-shaped body hollowed axially from its upper face towards the lower face to a base (6), comprising a door (1) located on one of the side faces of the body, so that a manipulator robot (3), with at least six axes, is installed on the surface of said base, in a central position marked by means of a base marking (9) centrally located on the surface of said base (6). Said door is fixed in a sliding manner upwards.

Around said robot are arranged a plurality of pre-staining vats (40), small staining vats (41), large staining vats (42) and post-drying vats (43) and a drying station (5), wherein the drying station comprises a grid (51) and a drawer (52), and further drying nozzles arranged around said station (5).

In addition, each staining vat has an internal basket (11) that accommodates the slides to ensure that they remain secure in this support, without disturbing the passage of the solution therethrough, and can be manufactured from polymeric material or steel stainless.

Around the entire aforementioned base (6), which has an infinite edge and is preferably made of rubberized material, holes (8) are arranged to drain the liquid, by gravity, to the liquid containment tray (7) which preferably has an inclined bottom (71) and optionally an attached drain mechanism, preferably a drain valve.

The present model further comprises a manifold located on some portion of the surface of the base (6) to control the input of gases into the drying nozzles (2).

Said axially hollow parallelepiped-shaped body is preferably made of stainless steel with a robust mechanical structure compatible with the operation of the robot, and the sides above the work base (6) are preferably transparent, more preferably made of acrylic with protection UV. A central unit to contain control/programming means for the robotic arm is preferably installed on the shelves inside the lower part of the bench.

The staining vats (40) (41) (42) (43) and/or washing are made of glass or acrylic and have an internal volume very close to the dimensions of the baskets (11) to minimize the amount of solution needed to reactions, generating less waste.

The drying station (5) consists of a liquid containment drawer (52) grated in its upper part to allow the passage of liquid, wherein said grid (51) is removably fixed. This station is surrounded by compressed air jets positioned in different positions surrounding said station to ensure rapid and homogeneous drying of the sample.

Additionally, the robotic arm can also direct a jet of compressed air at the samples to improve this drying. The main sequence of automated staining activities can be summarized by the steps below:
The robotic arm picks up the basket during pre-staining;
The robotic arm takes the basket to the first Solution (Staining), leaving it for a pre-determined time (e.g., 45 seconds) and maintaining agitation if necessary;
The robotic arm takes the basket to the second vat (Wash 1) and repeats the movement of going up and down in the liquid five times, maintaining agitation, when necessary, during the process;
The robotic arm takes the basket from there to the last vat (Wash 2) and repeats the process as carried out in “Wash 1”. Then, it take the basket to the drying station, if it is empty; otherwise, the basket must be left at the “rest point”;
The robotic arm moves to remove the previous basket (if it is not the first basket in the process) from the drying station and allocate the same to post-drying;
The robotic arm returns to the “rest point” and picks up the basket to take the same to the drying station;
The robotic arm picks up the drying jet, if necessary, and passes the same through the staining basket to assist with drying;
The robotic arm removes the basket from the drying station to place the same in post-drying;
The robotic arm picks up the next unstained basket and repeats the previous procedures. If there are no more baskets, it finishes the last drying cycle. If there is no more drying, the processes are completed and the compressed air lines that are still active are turned off.

In this way, the aforementioned model makes it possible to stain large quantities of slides in batches, and, as it has a high degree of automation, it allows the production of several batches in sequence, guaranteeing high productivity with excellent reproducibility, speeding up the preparation process for digitalization of many types of samples.

By using this model, it is possible to reduce the labor force specialized in staining petrographic slides, reduce the consumption of reagents, and reduce the generation of chemical waste that needs to be treated before disposal in the environment.

Said model, in addition, increases the precision of staining standardization and reproducibility, maintaining both the exact contact time with the reagents and the same movements throughout the reaction for any number of samples.

In cases where the coloring intensity is influenced by the reaction time, this precise control will facilitate the application of future studies using artificial intelligence for pattern detection. The body (1) of the bench has the function of isolating the robot's operating area, minimizing the risk of accidents with employees and the environment, in addition to providing ultraviolet protection for photosensitive solutions.

The robotic arm (2) mimics the movements performed in the past by the human operator, taking the baskets with slides through all stages of the process, from the initial rest, passing from one solution to another for the time necessary for each reaction and maintaining the necessary agitation at each stage, until it reaches the drying point, where it can also assist, if necessary.

Those skilled in the art will value the knowledge presented herein and will be able to reproduce the model in the presented embodiments and in other variants, encompassed by the scope of the attached claims.

1. A bench for automated staining of petrographic slides in batch comprising a parallelepiped-shaped body hollowed axially from its upper face towards the lower face to a base, comprising a door located on one of the side faces of the body and fixed in a sliding manner upwards, characterized in that, in a base marking located on the surface of said base in a centralized manner, a manipulator robot of at least six axes is installed, and around said robot there are arranged a plurality of pre-staining vats, small staining vats, large staining vats and post-drying vats and a drying station, wherein said vats comprise staining baskets and the drying station comprises a grid and a drawer, such that drying nozzles are arranged surrounding said station, and around all said infinite edge base, holes are arranged that end in the liquid containment tray that preferably comprises an inclined bottom.
